(19) United States
(12) Patent Application Publication
(10) Pub. No.: US 2018/0210977 A1
(43) Pub. Date: Jul. 26, 2018

(54) Systems and Methods for Automatic Reservoir Simulation Model Performance Tuning

(71) Applicant: Saudi Arabian Oil Company, Dhahran (SA)

(72) Inventors: Majdi A. Baddourah, Dhahran (SA); Ahmed S. Al-Zawawi, Dhahran (SA); Sulaiman Qannas, Dhahran (SA)

(21) Appl. No.: 15/412,950

(22) Filed: Jan. 23, 2017

(51) Int. Cl. G06F 17/50

(52) U.S. Cl. CPC G06F 17/5009

(57) ABSTRACT

A process and system for modifying reservoir simulation models and analyzing their associated execution on high-performance grid computing (HPGC) clusters with the objective of reducing overall turnaround time and improving cluster efficiency. The system modifies the original reservoir simulation model engineering data and simulator control parameters to optimal settings, which results in reducing run time while providing equal or better accuracy of the results. In addition, the system ensures that the HPGC resources are optimally used to minimize wastage due to over allocating of compute resources. The system checks the output file of every simulation run, and modifies the input of the run for optimal and accurate results using the present system. The system then either resubmits the run or saves the parameters for new runs. The saved parameters may be used for any run after the first run. The parameters may alternatively be automatically updated after each new run.

### TECHNICAL FIELD

Embodiments of the invention relate to hydrocarbon reservoir production and, more specifically, to methods, systems, and non-transitory computer-readable medium having computer program stored therein to enhance hydrocarbon reservoir simulation for a plurality of hydrocarbon reservoirs.

### BACKGROUND

In the oil and gas industries, massive amounts of data are required to be processed for computerized simulation, modeling, and analysis for exploration and production purposes. For example, the development of underground hydrocarbon reservoirs typically includes development and analysis of computer simulation models of the reservoir. These underground hydrocarbon reservoirs are typically complex rock formations which contain both a petroleum fluid mixture and water. The reservoir fluid content usually exists in two or more fluid phases. The petroleum mixture in reservoir fluids is produced by wells drilled into and completed in these rock formations.

A geologically-realistic model of the reservoir, and the presence of its fluids, also helps in forecasting the optimal future oil and gas recovery from hydrocarbon reservoirs. Oil and gas companies have come to depend on geological models as an important tool to enhance the ability to exploit a petroleum reserve.

In simulation and geological models, the reservoir is organized into a number of individual cells. Seismic data with increasing accuracy has permitted the cells to be on the order of 25 meters areal (x and y axis) intervals. For what are known as giant reservoirs, the number of cells is at least hundreds of millions, and reservoirs of what is known as giga-cell size (a billion cells or more) are encountered.

Similar considerations of data volume are also presented in seismic data processing. Seismic data obtained from surveys over large areas of the earth's surface, such as above giant reservoirs, has been acquired and made available in increased volumes. In processing vast amounts of data of all three of the types described above, processing time is an important consideration.

One type of computer system which has been available for processing the vast amounts of data of the types encountered in reservoir simulation has been high-performance grid computing (HPGC). A HPGC system takes the form of a group of powerful workstations or servers, joined together as a network to function as one supercomputer.

HPGC systems typically have been made available for three years replacement cycles for their computer hardware from the supplying HPGC manufacturer. Typically, a new HPGC system designed for running reservoir simulation has been bought every year either as a replacement for an older system, or as additional growth in compute requirements to run larger models. HPGC data centers with such replacement cycles thus typically have at least three generations of computer hardware available for use. These existing systems consume space, power and cooling. They also require maintenance support contracts. It is expected that these systems be utilized efficiently.

Generational differences between these systems have followed Moore's law where the number of transistors, and thus performance, doubled approximately every eighteen months to two years. The difference in performance and speed between first generation and third generation hardware of an installed HPGC grid available on the floor is typically on the order of three to four times. As a result, HPGC users have witnessed a dramatic increase in performance over the last ten years with regard to HPGC systems. What used to take one month of HPGC computation time ten years ago is now taking only a few hours to run in current HPGC systems.

### SUMMARY

Example embodiments relate to a process and system for modifying reservoir simulation models and analyzing their associated execution on HPGC clusters with the objective of reducing overall turnaround time and improving cluster efficiency. The system modifies the original reservoir simulation model engineering data and simulator control parameters to optimal settings, which results in reducing run time while providing equal or better accuracy of the results. In addition, the system ensures that the HPGC resources are optimally used to minimize wastage due to over allocating of compute resources. In some embodiments, modifying the input file may be automated to achieve better accuracy or optimal run time. The system checks the output file of every simulation run, and modifies the input of the run for optimal and accurate results using the present system. The system then either resubmits the run or saves the parameters for new runs. The saved parameters may be used for any run after the first run. The parameters may alternatively be automatically updated after each new run.

One example embodiment is a system for performance tuning of a hydrocarbon reservoir simulation model. The system includes one or more high-performance grid computing (HPGC) clusters comprising one or more processors, and a non-transitory computer-readable medium in communication with the one or more processors and having stored thereon a set of instructions that when executed cause the one or more processors to perform operations including examining an output file of a first run of the reservoir simulation, determining that the output file has low accuracy or does not meet a minimum performance level, modifying either engineering data or simulation control parameters of the reservoir simulation model, and resubmitting the first run of the reservoir simulation with the modified engineering data or modified simulation control parameters. The instructions further cause the one or more processors to perform operations including determining, in a first run of the reservoir simulation, that a solver ratio time is less than a first predetermined value, reducing the number of processors if the solver ratio time in the first run is less than the first predetermined value, and resubmitting the first run of the reservoir simulation with the reduced number of processors. The instructions further cause the one or more processors to perform operations including determining, in the first run of the reservoir simulation, that a change in pressure or saturation of a cell is higher than a second predetermined value, and modifying the reservoir simulation, for a second run, to include the cell with high pressure or saturation to have a porosity less than a dead cell porosity. The instructions further cause the one or more processors to perform operations including determining, in the first run of the reservoir simulation, that a material balance error is greater than a third predetermined value, reducing the material balance error, and resubmitting the first run of the reservoir simulation. The instructions further cause the one or more processors to perform operations including determining, in the first run of the reservoir simulation, that a total number of time steps over total number of time step cuts is less than a fourth predetermined value, and reducing a non-linear parameter to half if the total number of time steps over total number of time step cuts is less than the fourth predetermined value. The instructions further cause the one or more processors to perform operations including determining, in the first run of the reservoir simulation, that input-output time is greater than a fifth predetermined value, reducing one or more input-output parameters by a predetermined amount, and saving the one or more modified input-output parameters for a second run. The instructions further cause the one or more processors to perform operations including determining, in the first run of the reservoir simulation, that a critical parameter is less than a sixth predetermined value, setting the critical parameter to the sixth predetermined value, and resubmitting the first run of the reservoir simulation.

Another example embodiment is a method for performance tuning of a hydrocarbon reservoir simulation model running on a HPGC cluster. The method includes examining an output file of a first run of the reservoir simulation, determining that the output file has low accuracy or does not meet a minimum performance level, modifying either engineering data or simulation control parameters of the reservoir simulation model, and resubmitting the first run of the reservoir simulation with the modified engineering data or modified simulation control parameters. The method may also include determining, in a first run of the reservoir simulation, that a solver ratio time is less than a first predetermined value, reducing the number of processors if the solver ratio time in the first run is less than the first predetermined value, and resubmitting the first run of the reservoir simulation with the reduced number of processors. The method may also include determining, in the first run of the reservoir simulation, that a change in pressure or saturation of a cell is higher than a second predetermined value, and modifying the reservoir simulation, for a second run, to include the cell with high pressure or saturation to have a porosity less than a dead cell porosity. The method may further include determining, in the first run of the reservoir simulation, that a material balance error is greater than a third predetermined value, reducing the material balance error, and resubmitting the first run of the reservoir simulation. The method may further include determining, in the first run of the reservoir simulation, that a total number of time steps over total number of time step cuts is less than a fourth predetermined value, and reducing a non-linear parameter to half if the total number of time steps over total number of time step cuts is less than the fourth predetermined value. The method may also include determining, in the first run of the reservoir simulation, that input-output time is greater than a fifth predetermined value, reducing one or more input-output parameters by a predetermined amount, and saving the one or more modified input-output parameters for a second run. The method also includes determining, in the first run of the reservoir simulation, that a critical parameter is less than a sixth predetermined value, setting the critical parameter to the sixth predetermined value, and resubmitting the first run of the reservoir simulation.

Another example embodiment is a non-transitory computer-readable medium including instructions stored thereon, which when executed by one or more processors operatively coupled to the computer-readable medium, cause the one or more processors to perform operations including examining an output file of a first run of the reservoir simulation, determining that the output file has low accuracy or does not meet a minimum performance level, modifying either engineering data or simulation control parameters of the reservoir simulation model, and resubmitting the first run of the reservoir simulation with the modified engineering data or modified simulation control parameters. The instructions further cause the one or more processors to perform operations including determining, in a first run of the reservoir simulation, that a solver ratio time is less than a first predetermined value, reducing the number of processors if the solver ratio time in the first run is less than the first predetermined value, and resubmitting the first run of the reservoir simulation with the reduced number of processors. The instructions further cause the one or more processors to perform operations including determining, in the first run of the reservoir simulation, that a change in pressure or saturation of a cell is higher than a second predetermined value, and modifying the reservoir simulation, for a second run, to include the cell with high pressure or saturation to have a porosity less than a dead cell porosity. The instructions further cause the one or more processors to perform operations including determining, in the first run of the reservoir simulation, that a material balance error is greater than a third predetermined value, reducing the material balance error, and resubmitting the first run of the reservoir simulation. The instructions further cause the one or more processors to perform operations including determining, in the first run of the reservoir simulation, that a total number of time steps over total number of time step cuts is less than a fourth predetermined value, and reducing a non-linear parameter to half if the total number of time steps over total number of time step cuts is less than the fourth predetermined value. The instructions further cause the one or more processors to perform operations including determining, in the first run of the reservoir simulation, that input-output time is greater than a fifth predetermined value, reducing one or more input-output parameters by a predetermined amount, and saving the one or more modified input-output parameters for a second run. The instructions further cause the one or more processors to perform operations including determining, in the first run of the reservoir simulation, that a critical parameter is less than a sixth predetermined value, setting the critical parameter to the sixth predetermined value, and resubmitting the first run of the reservoir simulation.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 is a schematic block diagram of a prior art data processing system for HPGC.

FIG. 2 is a schematic illustration of a prior art data processing system for HPGC.

FIG. 3 is a schematic block diagram of a data processing system for high performance and grid computing, according to one or more example embodiments of the disclosure.

FIG. 4 illustrates example operations in an example method for carrying out reservoir simulation on HPGC clusters, according to one or more example embodiments of the disclosure.

FIG. 5 illustrates example operations in an example method for carrying out reservoir simulation on HPGC clusters, according to one or more example embodiments of the disclosure.

FIG. 6 illustrates example operations in an example method for carrying out reservoir simulation on HPGC clusters, according to one or more example embodiments of the disclosure.

FIG. 7 illustrates example operations in an example method for carrying out reservoir simulation on HPGC clusters, according to one or more example embodiments of the disclosure.

FIG. 8 illustrates example operations in an example method for carrying out reservoir simulation on HPGC clusters, according to one or more example embodiments of the disclosure.

### DETAILED DESCRIPTION

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

The present invention relates to HPGC of data for exploration and production of hydrocarbons, such as computerized simulation of hydrocarbon reservoirs in the earth, geological modeling, processing of seismic survey data, and other types of data gathered and processed to aid in the exploration and production of hydrocarbons. For the purposes of the present invention data of the foregoing types are referred to herein as exploration and production data. The present invention is particularly adapted for processing exploration and production data where vast amounts of such data are present, such as in or around what are known as giant reservoirs.

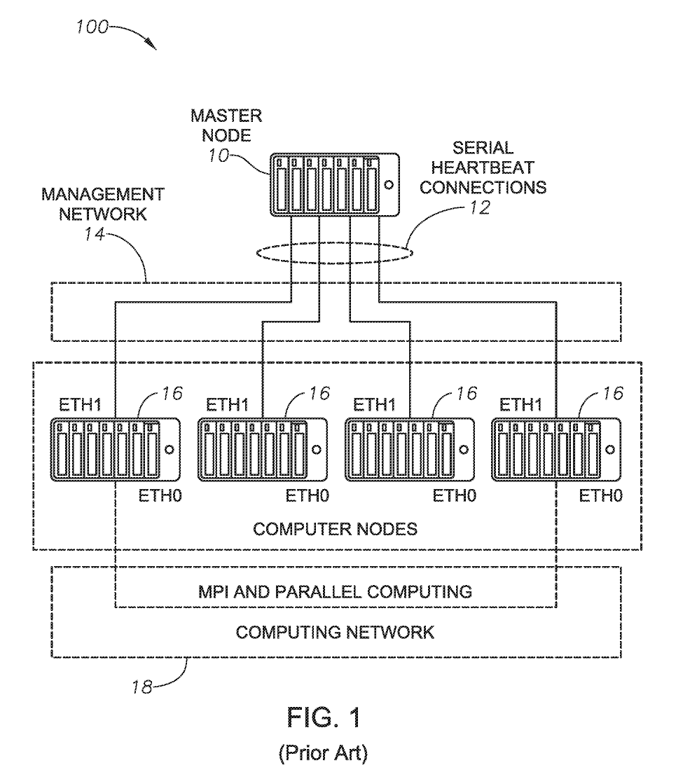

In the drawings, FIG. 1 represents an example prior art HPGC network 100. The HPGC network 100 is configured for parallel computing using the message passing interface (MPI) with a master node 10 transferring data through what are known as serial heartbeat connections over data links 12 of a management network 14 to a number of processor nodes 16. The processor nodes 16 are configured to communicate with each other as indicated at 18 according to the MPI standard communication library during parallel computing and processing of data. As has been set forth, so far as is known, standard communication libraries such as MPI and Parallel Virtual Machine (PVM) did not provide a capability for applications to specify service quality for computation and communication.

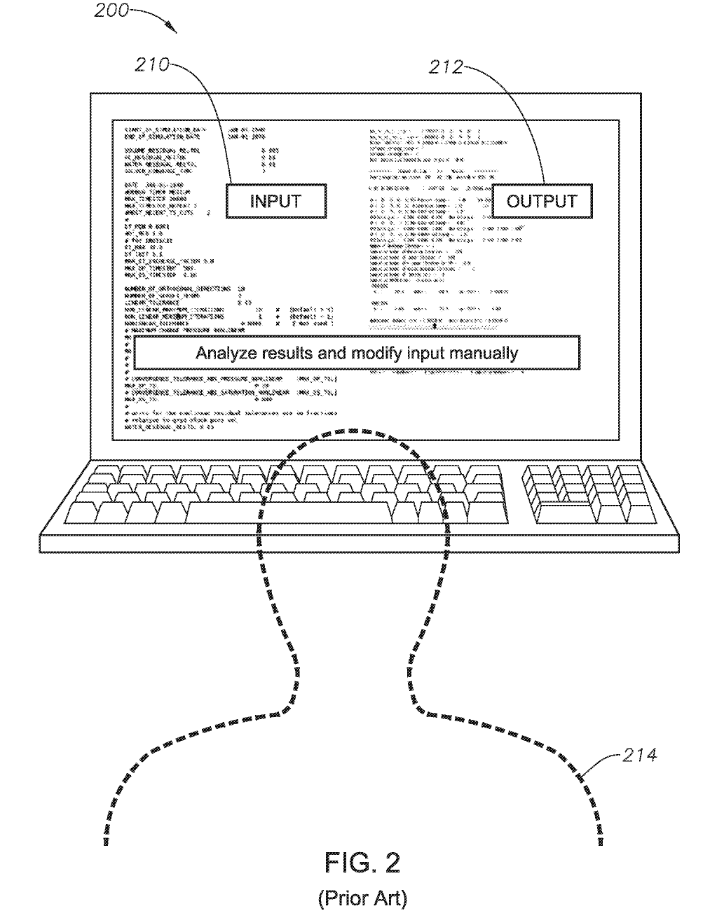

FIG. 2 illustrates another system 200 according to prior art. As illustrated in FIG. 2, an engineer or hydrocarbon well personnel 214 is expected to manually review the input 210 in a hydrocarbon reservoir simulation model, analyze the output or results 212, and manually modify input 210 to achieve better results. This process may be time consuming and prone to errors when the data involves copious amounts of information.

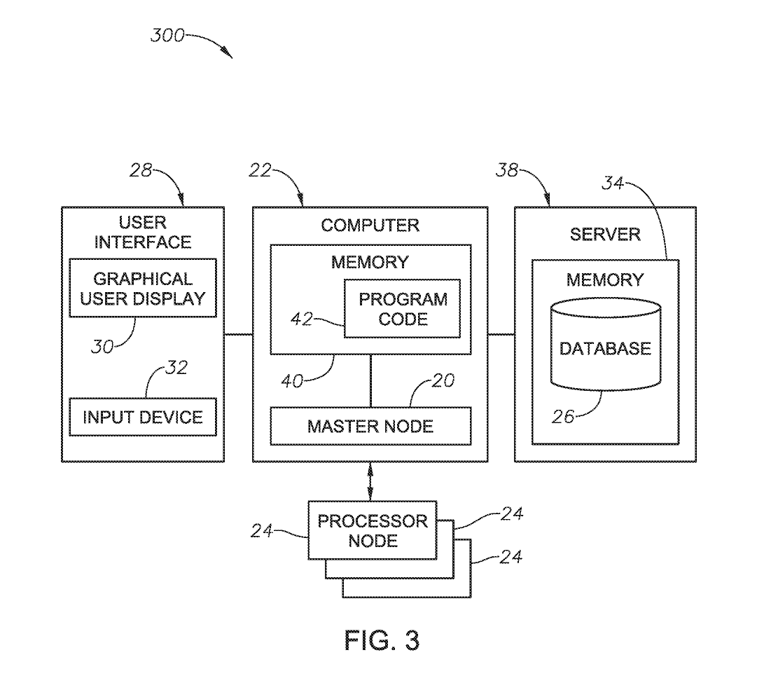

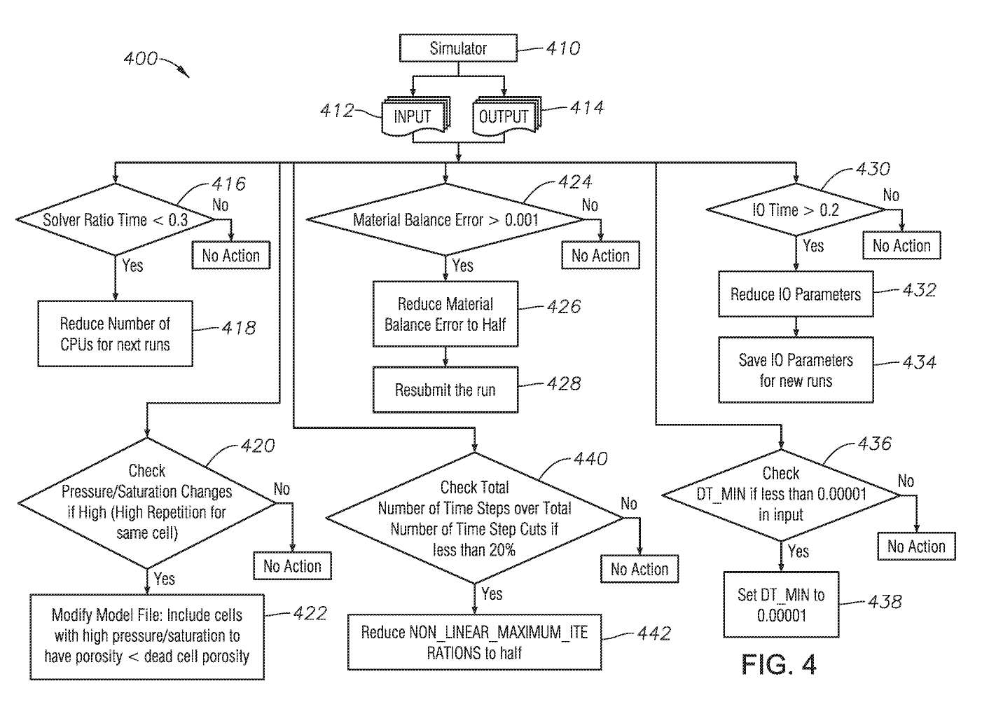

With the present invention, as is shown schematically in FIG. 3 in a data processing system 300 a master node 20 of a CPU 22 and a group of processor or worker nodes 24 operating as a network arranged for HPGC, depending on the configuration of the network, of exploration and production data. As will be set forth, the data processing system 300 processes exploration and production data with a controllable specified quality of service (QoS) for the processing applications. Data processing system 300 operates according to the processing techniques which are shown schematically in FIGS. 4-8. Thus, HPGC processing of exploration and production data are performed without impacting or losing processing time in case of failures. A data distribution service (DDS) standard is implemented in the HPGC platforms of the data processing system 300, to avoid shortcomings of MPI communication between computing modules, and provide QoS for such applications.

Considering now the data processing system according to the present invention, as illustrated in FIG. 3, the data processing system 300 is provided as a processing platform for HPGC of exploration and processing data. The data processing system 300 includes one or more central processing units or CPUs 22. The CPU or CPUs 22 have associated therewith a reservoir memory or database 26 for general input parameters, of a type and nature according to the exploration and production data being processed, whether reservoir simulation, geological modeling, seismic data or the like.

A user interface 28 operably connected with the CPU 22 includes a graphical display 30 for displaying graphical images, a printer or other suitable image forming mechanism and a user input device 32 to provide a user access to manipulate, access, and provide output forms of processing results, database records, and other information. The reservoir memory or database 26 is typically in a memory 34 of an external data storage server or computer 38. The reservoir database 26 contains data including the structure, location, and organization of the cells in the reservoir model, data general input parameters, as well as the exploration and production data to be processed, as will be described below.

The CPU or computer 22 of data processing system 300 includes the master node 20 and an internal memory 40 coupled to the master node 20 to store operating instructions, control information, and to serve as storage or transfer buffers as required. The data processing system 300 includes program code 42 stored in memory 40. The program code 42, according to the present invention, is in the form of computer operable instructions causing the master node 20 and processor nodes 24 to transfer the exploration and production data and control instructions back and forth according to DDS intercommunication techniques, as will be set forth.

It should be noted that program code 42 may be in the form of microcode, programs, routines, or symbolic computer operable languages that provide a specific set of ordered operations that control the functioning of the data processing system 300 and direct its operation. The instructions of program code 42 may be stored in memory 40 or on computer diskette, magnetic tape, conventional hard disk drive, electronic read-only memory, optical storage device, or other appropriate data storage device having a computer usable medium stored thereon. Program code 42 may also be contained on a data storage device as a computer readable medium.

The processor nodes 24 are general purpose, programmable data processing units programmed to perform the processing of exploration and production data according to the present invention. The processor nodes 24 operate under control of the master node 20 and the processing results obtained are then assembled in memory 34 where the data are provided for formation with user interface 28 of output displays to form data records for analysis and interpretation.

Although the present invention is independent of the specific computer hardware used, an example embodiment of the present invention is preferably based on a master node 20 and processor nodes 24 of an HP Linux cluster computer. It should be understood, however, that other computer hardware may also be used.

One example embodiment is a system 300 for modifying reservoir simulation models and analyzing their associated execution on HPGC clusters with the objective of reducing overall turnaround time and improving cluster efficiency. The system modifies the original reservoir simulation model engineering data and simulator control parameters to optimal settings, which results in reducing run time while providing equal or better accuracy of the results. In addition, the system ensures that the HPGC resources are optimally used to minimize wastage due to over allocating of compute resources. In some embodiments, modifying the input file may be automated to achieve better accuracy or optimal run time. The system checks the output file of every simulation run, and modifies the input of the run for optimal and accurate results using the present system. The system then either resubmits the run or saves the parameters for new runs. The saved parameters may be used for any run after the first run. The parameters may alternatively be automatically updated after each new run. Example embodiments disclosed automate the process of modifying the input file to achieve better accuracy or optimal run time. Example embodiments make sure results are checked and expert modifications are made to the input files.

Some embodiments relate to a process and system to modifying reservoir simulation models and analyzing their associated execution on HPGC clusters with the objective of reducing overall turnaround time and improving cluster efficiency. The developed system modifies the original reservoir simulation model engineering data and simulator control parameters to optimal settings, which results in reducing run time while providing equal or better accuracy of the results. In addition, the developed process ensures that the HPGC resources are optimally used minimizing wastage due to over allocating computing resources.

One example embodiment is system 300 for performance tuning of a hydrocarbon reservoir simulation model. The system 300 includes one or more HPGC clusters comprising one or more processors 22, 24, and a non-transitory computer-readable medium 40 in communication with one or more processors 22, 24 and having stored thereon a set of instructions 42 that when executed cause the one or more processors 22, 24 to perform operations including examining an output file of a first run of the reservoir simulation, determining that the output file has low accuracy or does not meet a minimum performance level, modifying either engineering data or simulation control parameters of the reservoir simulation model, and resubmitting the first run of the reservoir simulation with the modified engineering data or modified simulation control parameters.

Moving now to FIG. 4, illustrated are example operations in an example method 400 for carrying out reservoir simulation on HPGC clusters, according to one or more example embodiments of the disclosure.

The first step in the process 400 is to analyze the input parameters 412 and output or results 414 of a simulation run. In this example step, a tool or a simulator 410 running the reservoir simulation model is activated after each simulation run is completed. The simulator or tool 410 may be running on any of the processors 22, 24 shown in FIG. 3, for example. This tool or simulator 410 looks at the output 414 and the input 412 of the run and decides if the run needs to be optimized for better accuracy or better run time. If the run demonstrates poor accuracy, or is not meeting minimum performance levels, then action may be taken by the system to modify the input 412 of the current run, for example, model engineering data and simulator control parameters, and resubmit the run with the new the set of parameters. In addition, these optimized new parameters may be automatically used to override the parameters of similar suboptimal runs from the same reservoir model.

The method may also include modifying the model engineering data and simulator control parameters. This step may include resubmitting the job with less nodes if, for example, the solver time is not scaling. The solver time scalability can be determined from the solver percentage time to the total time. If the solver time ratio is less than 0.3 then the number of cores for this type of runs may be reduced for new runs. The system may use the new number of cores for better efficiency.

In another example, when the system determines that there is a high number of time step cuts, for example more than 20%, and the maximum number of nonlinear iterations is reached for 20% of the time step cuts, then the maximum number of nonlinear iterations may be reduced for new runs of the same model.

For jobs which terminate with time step cuts, the model file is updated to exclude cells which are causing time step cuts, for example cells which have high pressure change or saturation change. The porosity of such cells may be made less than the minimum porosity and the job may be resubmitted. For this type of problem, the minimum size of the time step may be reduced by dividing the minimum time step by 100 or so.

In one example embodiment, the system may update the recurrent file with the correct tolerance, with for example more tight tolerances, if there is bad material balance, for example material balance >0.001. The linear solver tolerances may be reduced by half to improve the material balance. The job may be resubmitted after making these adjustments.

In one example embodiment, if the ratio of the I/O time is more than 20%, the recurrent file may be modified to change the frequency of the I/O time and the modification may be saved for new runs.

The process above may be repeated multiple times till the optimal solution for a simulation run is achieved. The proposed technical solution is to check the output file of every simulation run, and modify the input of the run for optimal and accurate results using expert system. Then either resubmit the run or save the parameters for new runs. The saved parameters may be used for any run after the first run. The parameters may be updated, for example, after each new run.

A pilot experiment on the above described systems and methods was conducted, and it was observed that run time was reduced by 20% and the accuracy of every run with bad material balance was significantly improved. The current algorithm may be enforced on every run. The system may check the outcome for speed of run and accuracy of results. The tool 410 may ensure new runs to have better and more accurate results with less run time. The tool 410 may also analyze every run made and this does not depend on the engineer's experience.

One example embodiment is a method 400 for performance tuning of a hydrocarbon reservoir simulation model running on a HPGC cluster. The method 400 includes examining an output file 414 of a first run of the reservoir simulation, determining that the output file 414 has low accuracy or does not meet a minimum performance level, modifying either engineering data or simulation control parameters of the reservoir simulation model, and resubmitting the first run of the reservoir simulation with the modified engineering data or modified simulation control parameters. The method may include at step 416 determining, in a first run of the reservoir simulation, that a solver ratio time is less than a first predetermined value. The method may include at step 418 reducing the number of processors if the solver ratio time in the first run is less than the first predetermined value, and resubmitting the first run of the reservoir simulation with the reduced number of processors. The method may also include at step 420 determining, in the first run of the reservoir simulation, that a change in pressure or saturation of a cell is higher than a second predetermined value. At step 422 the method may include modifying the reservoir simulation, for a second run, to include the cell with high pressure or saturation to have a porosity less than a dead cell porosity. The method may further include at step 424 determining, in the first run of the reservoir simulation, that a material balance error is greater than a predetermined value. At step 426 if it is determined that a material balance error is greater than a predetermined value, then the method includes reducing the material balance error, and resubmitting the first run of the reservoir simulation at step 428. The method may further include at step 440 determining, in the first run of the reservoir simulation, that a total number of time steps over total number of time step cuts is less than a predetermined value. If the total number of time steps over total number of time step cuts is less than the predetermined value, then the method reduces a non-linear parameter to half in step 442. The method may also include at step 430 determining, in the first run of the reservoir simulation, that input-output time is greater than a predetermined value, reducing one or more input-output parameters by a predetermined amount at step 432, and saving the one or more modified input-output parameters for a second run in step 434. The method also includes at step 436 determining, in the first run of the reservoir simulation, that a critical parameter is less than a predetermined value, and setting the critical parameter to a predetermined value at step 438, and resubmitting the first run of the reservoir simulation.

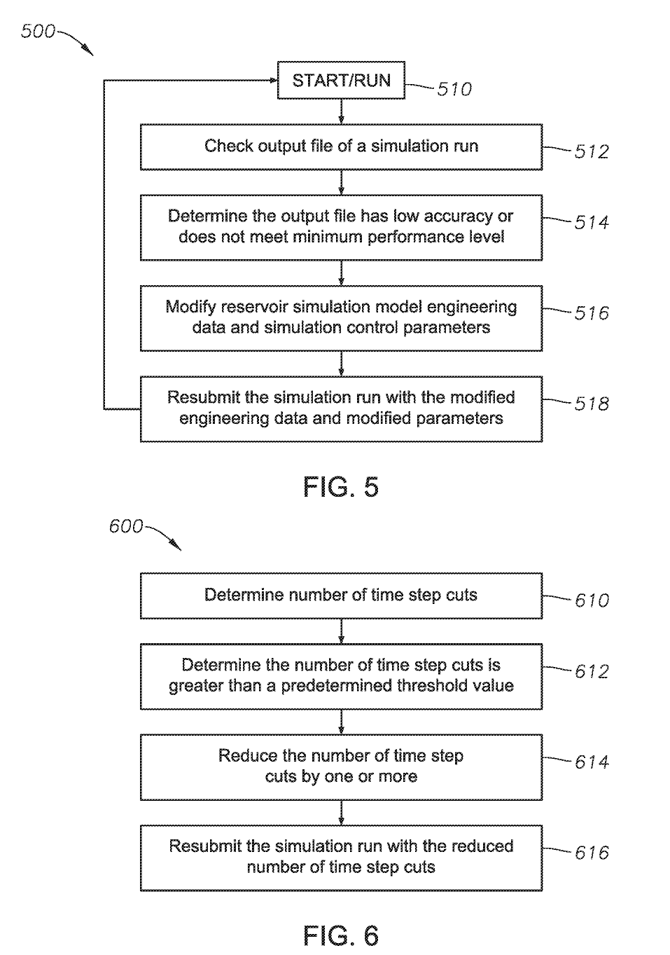

FIG. 5 illustrates a method 500 for performance tuning of a hydrocarbon reservoir simulation model running on a HPGC cluster. The method 500 includes initiating the simulation run at step 510, examining an output file of a first run of the reservoir simulation at step 512, determining that the output file has low accuracy or does not meet a minimum performance level at step 514, modifying either engineering data or simulation control parameters of the reservoir simulation model at step 516, and resubmitting the first run of the reservoir simulation with the modified engineering data or modified simulation control parameters at step 518.

FIG. 6 illustrates a method 600 for performance tuning of a hydrocarbon reservoir simulation model running on a HPGC cluster. When the system determines that there is a high number of time step cuts, for example more than 20%, and the maximum number of nonlinear iterations is reached for 20% of the time step cuts, then the maximum number of nonlinear iterations may be reduced for new runs of the same model. The method may include, for example, determining the number of time step cuts in step 610. The method may also include determining the number of time step cuts is greater than a predetermined threshold value in step 612. The method may also include reducing the number of time step cuts by one or more in step 614. The method may also include resubmitting the simulation run with the reduced number of time step cuts in step 616, for example.

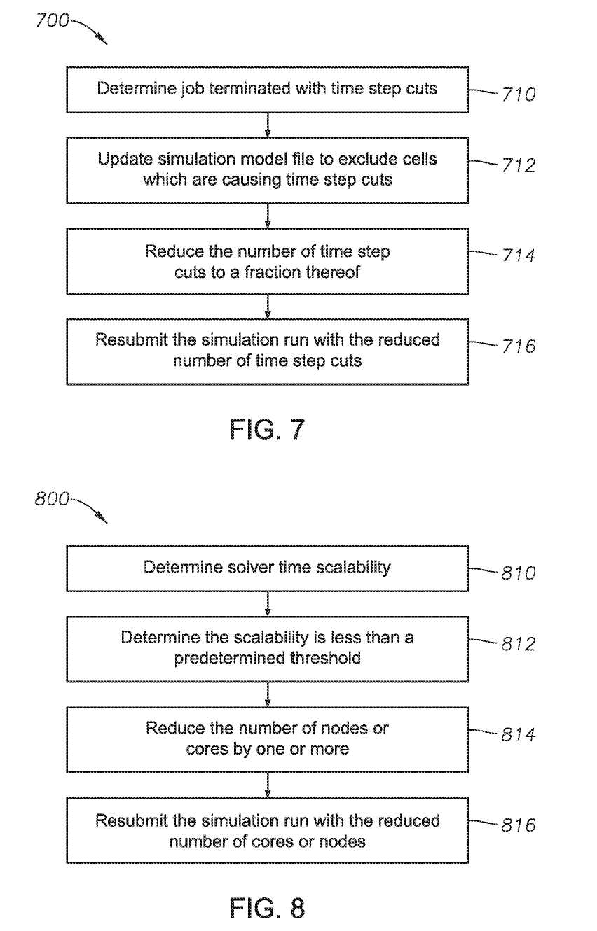

FIG. 7 illustrates a method 700 for performance tuning of a hydrocarbon reservoir simulation model running on a HPGC cluster. For jobs which terminate with time step cuts, the model file is updated to exclude cells which are causing time step cuts, for example cells which have high pressure change or saturation change. The porosity of such cells may be made less than the minimum porosity and the job may be resubmitted. For this type of problem, the minimum size of the time step may be reduced by dividing the minimum time step by 100 or so.

The method may include determining that the job was terminated with time step cuts in step 710. The method may also include updating the simulation model file to exclude cells which are causing time step cuts in step 712. The method may also include reducing the number of time step cuts to a fraction thereof in step 714. The method may also include resubmitting the simulation run with the reduced number of time step cuts in step 716, for example.

FIG. 8 illustrates a method 800 for performance tuning of a hydrocarbon reservoir simulation model running on a HPGC cluster. The method may include determining solver time scalability at step 810. The method may also include determining the scalability is less than a predetermined threshold at step 812. The method may also include modifying or reducing the model engineering data and simulator control parameters. For example, the method may include reducing the number of nodes or cores by one or more at step 814. The method 800 may include resubmitting the job with less nodes if, for example, the solver time is not scaling at step 816. The solver time scalability can be determined from the solver percentage time to the total time. If the solver time ratio is less than 0.3 then the number of cores for this type of runs may be reduced for new runs. The system may use the new number of cores for better efficiency.

Another example embodiment is a non-transitory computer-readable medium, such as memories 34, 42 as illustrated in FIG. 3, including instructions stored thereon, which when executed by one or more processors 22, 24 operatively coupled to the computer-readable medium 34, 42, cause the one or more processors 22, 24 to perform operations including examining an output file of a first run of the reservoir simulation, determining that the output file has low accuracy or does not meet a minimum performance level, modifying either engineering data or simulation control parameters of the reservoir simulation model, and resubmitting the first run of the reservoir simulation with the modified engineering data or modified simulation control parameters. The instructions further cause the one or more processors to perform operations including determining, in a first run of the reservoir simulation, that a solver ratio time is less than a first predetermined value, reducing the number of processors if the solver ratio time in the first run is less than the first predetermined value, and resubmitting the first run of the reservoir simulation with the reduced number of processors. The instructions further cause the one or more processors to perform operations including determining, in the first run of the reservoir simulation, that a change in pressure or saturation of a cell is higher than a second predetermined value, and modifying the reservoir simulation, for a second run, to include the cell with high pressure or saturation to have a porosity less than a dead cell porosity. The instructions further cause the one or more processors to perform operations including determining, in the first run of the reservoir simulation, that a material balance error is greater than a third predetermined value, reducing the material balance error, and resubmitting the first run of the reservoir simulation. The instructions further cause the one or more processors to perform operations including determining, in the first run of the reservoir simulation, that a total number of time steps over total number of time step cuts is less than a fourth predetermined value, and reducing a non-linear parameter to half if the total number of time steps over total number of time step cuts is less than the fourth predetermined value. The instructions further cause the one or more processors to perform operations including determining, in the first run of the reservoir simulation, that input-output time is greater than a fifth predetermined value, reducing one or more input-output parameters by a predetermined amount, and saving the one or more modified input-output parameters for a second run. The instructions further cause the one or more processors to perform operations including determining, in the first run of the reservoir simulation, that a critical parameter is less than a sixth predetermined value, setting the critical parameter to the sixth predetermined value, and resubmitting the first run of the reservoir simulation.

The present invention provides the capability to physically expand the HPGC processing systems for reservoir simulation on an HPGC grid. The present invention also provides a domain decomposition technique to achieve higher load balancing and computational efficiency. The expansion of the HPGC infrastructure to grid computing is accompanied by adaptive detection of the available mix of resources. The reservoir simulation decomposition methodology in effect adaptively learns about the underlying hardware and different processor generations, and adjusts the distribution of load based on these resources to minimize the processing runtime for the simulator. Accordingly, the present invention provides the ability to efficiently run larger reservoir simulation models on heterogeneous high performance computing grids. In contrast, conventional methods where domain decompositions were used in simulation were suited for only homogenous set of processors in the cluster.

It can thus be seen that the present invention provides a scalable and expandable HPGC environment for reservoir simulation, and in particular large-scale reservoir simulation in what are known as giant reservoirs. The present invention overcomes processing slowness encountered in HPGC with a mixture of older and newer generations of sub-clusters resulting in significant cost savings and upgrades the processing speed to that of the fastest generation of processors.

Simulation models are developed to predict field production performance. They are used to develop strategic surveillance plans for fields and to evaluate sweep efficiency and optimize recovery. Users can use old and new compute resources simultaneously with no slowdown of the simulation process. This provides for running extremely large models that also were not, so far as is known, available before. Another major benefit is to ensure long-term integrity of reservoirs and providing dynamic assessment of reserves to maximize ultimate recovery.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

1. A system for performance tuning of a hydrocarbon reservoir simulation model, the system comprising:
one or more high-performance grid computing (HPGC) clusters comprising one or more processors; and
a non-transitory computer-readable medium in communication with the one or more processors and having stored thereon a set of instructions that when executed cause the one or more processors to perform operations comprising:
examining an output file of a first run of the reservoir simulation;
determining that the output file has low accuracy or does not meet a minimum performance level;
modifying either engineering data or simulation control parameters of the reservoir simulation model; and
resubmitting the first run of the reservoir simulation with the modified engineering data or modified simulation control parameters.

2. The system of claim 1, wherein the instructions further cause the one or more processors to perform operations comprising:
determining, in the first run of the reservoir simulation, that a solver ratio time is less than a first predetermined value;
reducing the number of processors if the solver ratio time in the first run is less than the first predetermined value; and
resubmitting the first run of the reservoir simulation with the reduced number of processors.

3. The system of claim 1, wherein the instructions further cause the one or more processors to perform operations comprising:
determining, in the first run of the reservoir simulation, that a change in pressure or saturation of a cell is higher than a second predetermined value; and
modifying the reservoir simulation, for a second run, to include the cell with high pressure or saturation to have a porosity less than a dead cell porosity.

4. The system of claim 1, wherein the instructions further cause the one or more processors to perform operations comprising:
determining, in the first run of the reservoir simulation, that a material balance error is greater than a third predetermined value;
reducing the material balance error; and
resubmitting the first run of the reservoir simulation.

5. The system of claim 1, wherein the instructions further cause the one or more processors to perform operations comprising:
determining, in the first run of the reservoir simulation, that a total number of time steps over total number of time step cuts is less than a fourth predetermined value; and
reducing a non-linear parameter to half if the total number of time steps over total number of time step cuts is less than the fourth predetermined value.

6. The system of claim 1, wherein the instructions further cause the one or more processors to perform operations comprising:
determining, in the first run of the reservoir simulation, that input-output time is greater than a fifth predetermined value;
reducing one or more input-output parameters by a predetermined amount; and
saving the one or more modified input-output parameters for a second run.

7. The system of claim 1, wherein the instructions further cause the one or more processors to perform operations comprising:
determining, in the first run of the reservoir simulation, that a critical parameter is less than a sixth predetermined value;
setting the critical parameter to the sixth predetermined value; and
resubmitting the first run of the reservoir simulation.

8. A method for performance tuning of a hydrocarbon reservoir simulation model running on a HPGC cluster, the method comprising:
examining an output file of a first run of the reservoir simulation;
determining that the output file has low accuracy or does not meet a minimum performance level;
modifying either engineering data or simulation control parameters of the reservoir simulation model; and
resubmitting the first run of the reservoir simulation with the modified engineering data or modified simulation control parameters.

9. The method of claim 8, further comprising:
determining, in the first run of the reservoir simulation, that a solver ratio time is less than a first predetermined value;
reducing the number of processors if the solver ratio time in the first run is less than the first predetermined value; and
resubmitting the first run of the reservoir simulation with the reduced number of processors.

10. The method of claim 8, further comprising:
determining, in the first run of the reservoir simulation, that a change in pressure or saturation of a cell is higher than a second predetermined value; and
modifying the reservoir simulation, for a second run, to include the cell with high pressure or saturation to have a porosity less than a dead cell porosity.

11. The method of claim 8, further comprising:
determining, in the first run of the reservoir simulation, that a material balance error is greater than a third predetermined value;
reducing the material balance error; and
resubmitting the first run of the reservoir simulation.

12. The method of claim 8, further comprising:
determining, in the first run of the reservoir simulation, that a total number of time steps over total number of time step cuts is less than a fourth predetermined value; and
reducing a non-linear parameter to half if the total number of time steps over total number of time step cuts is less than the fourth predetermined value.

13. The method of claim 8, further comprising:
determining, in the first run of the reservoir simulation, that input-output time is greater than a fifth predetermined value;
reducing one or more input-output parameters by a predetermined amount; and
saving the one or more modified input-output parameters for a second run.

14. The method of claim 8, further comprising:
determining, in the first run of the reservoir simulation, that a critical parameter is less than a sixth predetermined value;
setting the critical parameter to the sixth predetermined value; and
resubmitting the first run of the reservoir simulation.

15. A non-transitory computer-readable medium including instructions stored thereon, which when executed by one or more processors operatively coupled to the computer-readable medium, cause the one or more processors to perform operations comprising:
examining an output file of a first run of the reservoir simulation;
determining that the output file has low accuracy or does not meet a minimum performance level;
modifying either engineering data or simulation control parameters of the reservoir simulation model; and
resubmitting the first run of the reservoir simulation with the modified engineering data or modified simulation control parameters.

16. The medium of claim 8, wherein the instructions further cause the one or more processors to perform operations comprising:
determining, in the first run of the reservoir simulation, that a solver ratio time is less than a first predetermined value;
reducing the number of processors if the solver ratio time in the first run is less than the first predetermined value; and
resubmitting the first run of the reservoir simulation with the reduced number of processors.

17. The medium of claim 8, wherein the instructions further cause the one or more processors to perform operations comprising:
determining, in the first run of the reservoir simulation, that a change in pressure or saturation of a cell is higher than a second predetermined value; and
modifying the reservoir simulation, for a second run, to include the cell with high pressure or saturation to have a porosity less than a dead cell porosity.

18. The medium of claim 8, wherein the instructions further cause the one or more processors to perform operations comprising:
determining, in the first run of the reservoir simulation, that a material balance error is greater than a third predetermined value;
reducing the material balance error; and
resubmitting the first run of the reservoir simulation.

19. The medium of claim 8, wherein the instructions further cause the one or more processors to perform operations comprising:
determining, in the first run of the reservoir simulation, that a total number of time steps over total number of time step cuts is less than a fourth predetermined value; and
reducing a non-linear parameter to half if the total number of time steps over total number of time step cuts is less than the fourth predetermined value.

20. The medium of claim 8, wherein the instructions further cause the one or more processors to perform operations comprising:
determining, in the first run of the reservoir simulation, that input-output time is greater than a fifth predetermined value;
reducing one or more input-output parameters by a predetermined amount; and
saving the one or more modified input-output parameters for a second run.
